(19) United States
(12) Patent Application Publication
(10) Pub. No.: US 2026/0370469 A1
(43) Pub. Date: Nov. 19, 2026

(54) SYSTEMS AND METHODS FOR USING MAPPING STRUCTURES TO PROCESS NON-CONFORMING DATA THROUGH COMPUTER NETWORKS

(71) Applicant: Capital One Services, LLC, McLean, VA (US)

(72) Inventors: Alberto Purpura, McLean, VA (US); Nicholas Lamm, Croton on Hudson, NY (US); Emily Chen, McLean, VA (US); Himanshu Kumar, McLean, VA (US)

(73) Assignee: Capital One Services, LLC, McLean, VA (US)

(21) Appl. No.: 19/212,610

(22) Filed: May 19, 2025

(51) Int. Cl. H04L 9/32; G06F 16/334

(52) U.S. Cl. CPC H04L 9/32; G06F 16/3347

(57) ABSTRACT

Systems and methods for using mapping structures to process non-conforming data through computer networks. For example, the system may receive, via a user interface, a user input. The system may determine a prompt token based on the user input. The system may determine a token embedding based on the prompt token, wherein the token embedding is mapped to an input layer of a network based on a mapping structure. The system may receive a vector representation of supplemental data. The system may determine a supplemental embedding for the vector representation based on the mapping structure. The system may process the token embedding and the supplemental embedding through the network to generate an output.

### BACKGROUND

Processing data through computer networks is technically difficult due to several interrelated challenges. First, network environments are inherently unpredictable and prone to latency, jitter, and packet loss, which can significantly impact data transmission reliability and speed. This unpredictability is exacerbated when dealing with large volumes of data or real-time processing requirements, such as in video conferencing or online gaming. Second, ensuring data security and integrity as it travels across potentially untrusted and heterogeneous networks requires robust encryption, authentication, and error-detection mechanisms, which add computational overhead and complexity. Third, differences in network protocols, hardware, and software across systems require careful standardization and compatibility handling to ensure seamless communication. Additionally, maintaining scalability and efficiency in distributed systems—especially in cloud or edge computing contexts—requires sophisticated load balancing, data synchronization, and fault-tolerance strategies. Together, these technical considerations make data processing over networks a complex and demanding task.

A type of computer network like a large language model (LLM) compounds the challenges of processing data through computer networks due to its immense scale, computational demands, and sensitivity to latency and synchronization. LLMs consist of billions of parameters and require vast amounts of data to operate effectively, meaning that even minor inefficiencies in data transmission or processing can lead to significant slowdowns or errors. These models often run across distributed systems with multiple GPUs or TPUs, necessitating precise coordination and high-speed data exchange to maintain performance and model coherence. This distributed nature increases the risk of bottlenecks, inconsistencies, and failures, especially when operating over less predictable or lower-bandwidth network connections. Furthermore, LLMs are typically sensitive to timing and input ordering, so any network delay, packet loss, or desynchronization can compromise output quality. Security and privacy concerns are also magnified, as the sensitive data being processed or transmitted must be protected against interception or leakage at scale. Thus, the size, complexity, and distributed processing demands of large language models intensify the existing difficulties of network-based data processing.

### SUMMARY

Methods and systems are described herein for novel uses and/or improvements to processing data through computer networks. For example, as mentioned above, the complexity of computer networks in general, and LLMs in particular, often leads to inefficient data processing, slower response times, wasted resources, and inaccuracies in outputs due to the intricate interplay of hardware, software, and communication protocols involved. In general, computer networks must manage data routing, error correction, synchronization, and security across diverse and often geographically distributed systems. These tasks introduce overhead and delays, particularly when networks experience congestion, packet loss, or varying latency. When LLMs are deployed on such networks, these issues are amplified because LLMs demand high-throughput, low-latency connections to coordinate computations across multiple processing units. Any disruption or delay in data flow can stall processing, forcing systems to wait or retry, which wastes computational resources and slows overall performance. Moreover, inconsistent or out-of-order data delivery can cause desynchronization between model components, leading to degraded accuracy or flawed responses. The massive size and sensitivity of LLMs to timing and input coherence mean that even minor inefficiencies in the network can cascade into significant performance and reliability problems, ultimately hindering their effectiveness and dependability in real-world applications.

Generating text conditioned on a vector in addition to a textual prompt helps solve or mitigate many of the challenges associated with complex computer networks and large language models by providing a compact, efficient, and semantically rich representation of data. Vectors, such as embeddings, encapsulate detailed information about an entity—like a customer profile, an image, or a document corpus—into a fixed-size numerical format that is easy to transmit, store, and integrate into model inputs. This bypasses the need to convert large or complex datasets into verbose textual descriptions, which would otherwise increase prompt length, processing time, and network load. By incorporating vectors directly into the generation process, models can access relevant context in a dense and structured form, improving efficiency and accuracy while reducing the likelihood of omissions or misunderstandings.

Moreover, conditioning models on vectors in addition to textual prompts also mitigates several limitations inherent to LLMs themselves, particularly the constraint of limited input prompt length. LLMs are typically restricted to a fixed number of tokens per input, and when prompts need to encode rich contextual information—such as detailed user profiles, long documents, or extensive background knowledge—this token limit can be quickly exhausted. Vectors offer a powerful solution by condensing complex, high-dimensional information into a compact numerical form that requires significantly fewer tokens or can be integrated directly into the model architecture without using up token space. This allows the model to access rich context without overloading the prompt, preserving room for other important information and instructions. Moreover, vectors provide a more structured and consistent representation of context, reducing variability and noise that can arise from verbose or ambiguous text-based prompts. By enhancing context efficiency and precision, vector-based conditioning improves output relevance, reduces hallucination risks, and enables more scalable, adaptable applications of LLMs across tasks like personalization, retrieval-augmented generation, and long-context understanding.

Unfortunately, conditioning models on vectors in addition to textual prompts introduces a novel technical challenge because these vectors do not naturally align with the model's existing architecture, particularly the input embedding layer designed specifically for tokenized text. In traditional LLMs, input text is first converted into token embeddings that are mapped directly to the model's input layer, enabling a seamless flow through the transformer architecture. However, external vectors—such as user embeddings, image embeddings, or document-level representations—do not originate from this tokenization process and therefore lack a direct correspondence to the model's initial input space. This mismatch creates an integration problem: the model must be adapted to accept and meaningfully process these vectors without disrupting the learned structure and behavior of the network.

To overcome this novel technical problem, the systems and methods determine a supplemental embedding for a vector representation based on a mapping structure for text embeddings. For example, determining a supplemental embedding for a vector representation based on the same or analogous mapping structure used for text embeddings into an existing model offers a practical solution to the technical challenge of integrating non-textual context (e.g., non-conforming data) into the model. By learning or defining a transformation that maps the external vector—such as a customer profile, image embedding, or document summary—into the same representational space as token embeddings, the model can ingest this supplemental information without disrupting its native architecture. This supplemental embedding acts as a “surrogate token” that is inserted into the model's input stream or injected through other conditioning mechanisms (e.g., as a prefix, soft prompt, or via cross-attention), allowing the model to process it alongside normal text. Because the transformed vector now shares structural properties with traditional embeddings, it can flow through the network without requiring extensive modifications to the input layer or core transformer blocks. This approach maintains compatibility with pre-trained weights and leverages the model's existing capacity to learn contextual relationships, enabling efficient and scalable fusion of multimodal or auxiliary information. In doing so, it mitigates the integration barrier while preserving the model's robustness and inference efficiency.

In some aspects, systems and methods for using mapping structures to process non-conforming data through computer networks are described. For example, the system may receive, via a user interface, a user input. The system may determine a prompt token based on the user input. The system may determine a token embedding based on the prompt token, wherein the token embedding is mapped to an input layer of a network based on a mapping structure. The system may receive a vector representation of supplemental data. The system may determine a supplemental embedding for the vector representation based on the mapping structure. The system may process the token embedding and the supplemental embedding through the network to generate an output. The system may generate for display, on the user interface, a response based on the output.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a user interface, in accordance with one or more embodiments.

FIG. 2 shows an illustrative diagram for architecture for mapping structures to process non-conforming data, in accordance with one or more embodiments.

FIG. 3 shows illustrative components for a system used to process non-conforming data, in accordance with one or more embodiments.

FIG. 4 shows a flowchart of the steps involved in for using mapping structures to process non-conforming data, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

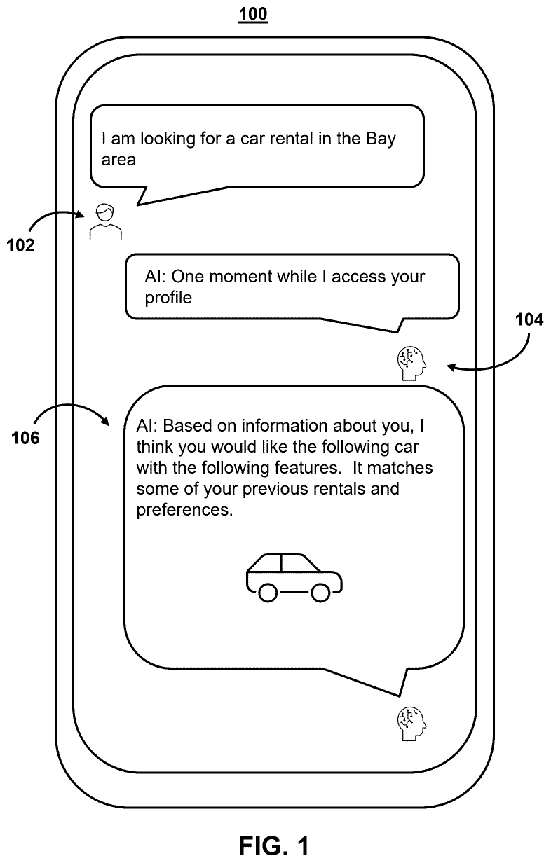

FIG. 1 shows an illustrative diagram for a user interface, in accordance with one or more embodiments. For example, FIG. 1 shows user interface 100. A user interface may be a point of interaction between a human user and a computer system, application, or device, enabling communication and control through visual, auditory, or tactile means. It may encompass the design, layout, and functionality of elements such as buttons, menus, input fields, icons, and displays that allow users to navigate and interact with digital systems. The primary goal of a user interface may be to facilitate seamless and intuitive interaction, making complex technological processes accessible and manageable for users with varying levels of technical expertise.

User interface 100 shows an interaction between a user (e.g., user 102) and an application (e.g., application 104). Based on user inputs from user 102 and information about user 102 from a vector representation), application 104 is able to generate response 106. Response 106 is able to quickly determine hyper-customized content for user 102.

As described herein, inputs to a user interface by a user may be the actions or data provided to a system to initiate a function, make a request, or communicate intent. These inputs can take various forms depending on the type of interface and device. Types may include textual input (such as typing a search query or filling out a form), tactile input (like tapping, swiping, or dragging on a touchscreen), mouse input (clicks and movements), voice input (speaking commands to a virtual assistant), and gesture or motion input (used in interfaces with motion sensors or cameras). More advanced interfaces may also accept biometric inputs (such as fingerprint scans or facial recognition) or sensor-based inputs (like those from a GPS or accelerometer).

A response from a user interface may be the system's output or reaction to the user's input, providing feedback, results, or further interaction options. Responses can also be categorized into several types: visual responses (like displaying search results, animations, or alert messages), auditory responses (such as spoken replies or notification sounds), haptic responses (like vibrations or force feedback), and multimodal responses that combine several forms. Effective responses not only acknowledge user input but also guide the next steps, reinforce user confidence, and contribute to a smooth and informative interaction experience.

For example, as shown in FIG. 1, determining a supplemental embedding for a vector representation based on the same or an analogous mapping structure used for text embeddings offers a practical solution to integrating non-textual context—such as user profile data—into the model. In FIG. 1, user interface 100 hosts a conversation between a user (e.g., user 102) and an AI-driven application (e.g., application 104), which generates a personalized response (e.g., response 106) by leveraging prior knowledge about the user. This knowledge is stored as a vector embedding—a condensed, information-rich representation of the user's preferences and behaviors. Because this vector does not originate from tokenized text, it cannot be fed directly into the language model's standard input pipeline without modification.

By projecting this vector into a supplemental embedding space that mirrors the format and dimensional structure of the model's text embeddings, the application bridges the architectural gap between structured user data and natural language generation. This allows the model to “read” and contextualize the user profile as if it were part of the prompt, without consuming token space or requiring a verbose, less efficient textual encoding. The result, as shown in response 106, is a highly personalized and context-aware reply—generated rapidly and efficiently—because the model can internally condition its output on dense, pre-computed knowledge about the user. This approach minimizes latency, optimizes the use of the model's token limit, and improves output accuracy, making it ideal for real-time, user-specific applications like intelligent search, recommendations, and interactive assistants.

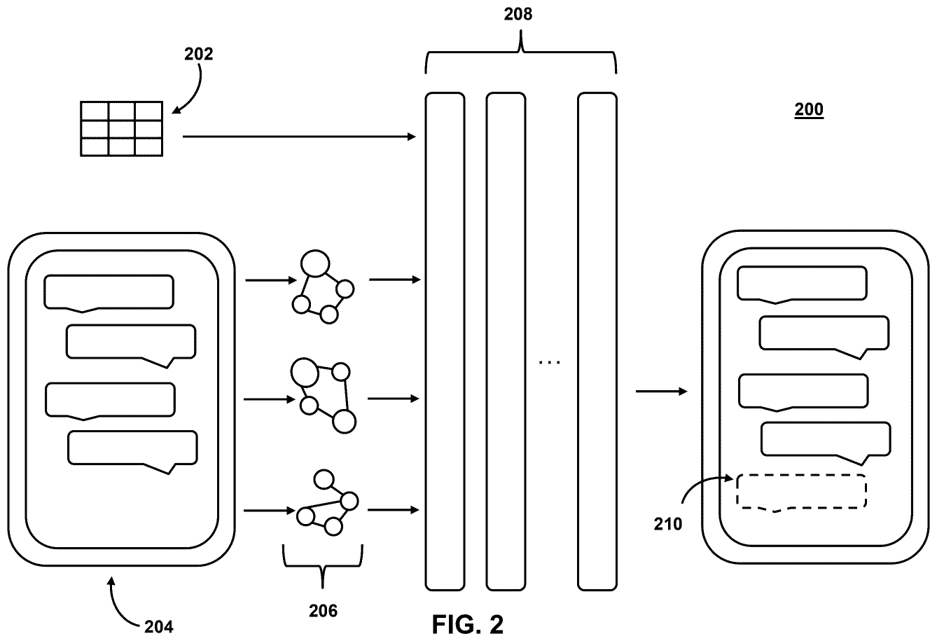

FIG. 2 shows an illustrative diagram for architecture for mapping structures to process non-conforming data, in accordance with one or more embodiments. For example, system 200 includes vector representation 202 and prompt tokens 204 being fed into a first self-attention layer of model 208 to generate output 210. As shown in system 200, prompt tokens 204 may use a respective token embedding (e.g., embedding 206), wherein the token embedding is mapped to an input layer of a network (e.g., model 208) based on a mapping structure. System 200 may also determine a supplemental embedding for vector representation 202 to allow supplemental data from vector representation 202 to be input into model 208.

For example, System 200, as illustrated in FIG. 2, provides a flexible and scalable architecture for integrating non-conforming data—such as structured vector representations—into a language model that is traditionally designed to process tokenized text. In this architecture, both vector representation 202 and prompt tokens 204 are inputs to a shared neural model, such as a transformer-based large language model (e.g., model 208). Prompt tokens 204 are processed using corresponding token embeddings (e.g., embedding 206), which are mapped to the input layer of the model based on a predefined mapping structure that ensures compatibility with the model's self-attention mechanisms. This mapping structure encodes textual tokens into high-dimensional vectors that the model can interpret as part of its natural language processing pipeline.

A prompt token may be a discrete unit of text—typically a word, subword, or character—that has been processed through tokenization and is used as input to a language model. Prompt tokens are derived from the user's input or system-generated text and represent the building blocks that the model analyzes to understand the context, intent, and structure of a given prompt. Each token is mapped to a corresponding vector through a learned embedding layer, which transforms the symbolic token into a high-dimensional numerical representation that the model can process. These embedded tokens are then passed through the model's layers—such as self-attention mechanisms in transformers—to generate meaningful outputs, such as predictions, completions, or classifications. Prompt tokens form the core input of natural language processing systems and are central to how models interpret and respond to textual prompts, enabling them to reason over language and generate coherent, contextually relevant responses.

A token embedding may be a high-dimensional numerical vector that represents a single token—such as a word, subword, or character—in a form that a machine learning model, particularly a language model, can understand and process. This embedding is generated by mapping each token to a specific vector within an embedding matrix, which is a learnable parameter of the model. During training, the model adjusts these vectors so that tokens used in similar linguistic or semantic contexts end up with similar embeddings. This allows the model to capture relationships between words, such as similarity, analogy, or syntactic roles, in a mathematically meaningful way. The token embedding serves as the first layer of input to the model's architecture, transforming raw, symbolic language into a continuous space where neural computations can take place. This foundational transformation enables the model to interpret, compare, and reason over text data, making token embeddings essential to the performance and generalization capabilities of modern natural language processing systems.

For example, a mapping structure encodes textual tokens into high-dimensional vectors through a process known as embedding, which transforms each discrete token—typically a word, subword, or character—into a continuous numerical representation that captures its syntactic and semantic properties. This transformation is achieved using an embedding matrix, which is a learned parameter of the model where each row corresponds to a unique token in the vocabulary and contains a vector of fixed dimensionality. When a token is input into the model, it is first converted to an index, which is then used to retrieve the corresponding vector from the embedding matrix. These high-dimensional vectors serve as the initial layer of input to the model, preserving spatial and relational information that allows the model to understand context, meaning, and patterns across sequences. During training, the embedding matrix is updated such that tokens used in similar contexts are placed closer together in the vector space, enabling the model to generalize linguistic relationships and make meaningful predictions. This embedding-based mapping structure is essential to natural language processing pipelines, as it bridges the gap between symbolic language and the numerical operations performed by neural networks.

As described herein, supplement data may refer to additional or auxiliary information that complements the primary input in a computational system, especially within machine learning and natural language processing contexts. This data provides context, personalization, or domain-specific knowledge that enhances the system's ability to make accurate predictions or generate relevant outputs. Unlike the main input—such as a user's textual prompt—supplement data may include structured metadata, user preferences, historical interactions, embeddings of prior documents, or non-textual representations like images or numerical vectors. It is typically used to inform the model without being explicitly included in the user-facing input, often through mechanisms like supplemental embeddings. By incorporating supplement data, systems can tailor responses more effectively, improve context understanding, and support complex tasks such as personalized recommendations, search relevance ranking, or multimodal generation.

To support the integration of non-textual, supplemental data—such as the user profile or other contextual information encapsulated in vector representation 202—system 200 determines a supplemental embedding that aligns with the same or an analogous mapping structure used for token embeddings. This transformation allows the supplemental embedding to be processed in parallel (and/or in combination) with token embeddings within the same attention layers of model 208. By harmonizing both types of inputs at the embedding level, system 200 ensures that the model can leverage rich, structured vector information in the generation or classification of natural language without exceeding prompt token limits or disrupting the model's internal architecture. The combined input is passed through the self-attention layers of model 208 to generate output 210, which represents a contextually enhanced and accurate response. This approach effectively solves the technical challenge of incorporating non-conforming data by adapting it into a form that fits the model's expected input format, enabling more nuanced and personalized outputs.

For example, a system may determine a supplemental embedding that aligns with the same or an analogous mapping structure used for token embeddings by applying a transformation function or projection mechanism that maps the non-textual input—such as a vector representation of user data, images, or other structured information—into the same high-dimensional space as the token embeddings. This is typically achieved through a learnable neural network layer, such as a feedforward projection or a small encoder module, that takes the external vector as input and outputs an embedding of the same dimensionality and statistical characteristics as those generated by the token embedding matrix. The key is to ensure that the resulting supplemental embedding is compatible with the model's input layer, allowing it to be processed seamlessly alongside traditional token embeddings. During training, this transformation is optimized so that the system learns to encode the supplemental information in a way that is semantically meaningful to the model, enabling the model to incorporate it effectively into its attention and reasoning mechanisms. By aligning the supplemental embedding with the structure and format of token embeddings, the system extends the model's contextual understanding without altering its core architecture, thus enabling richer, more informed outputs.

In some embodiments, a supplemental embedding may be a high-dimensional vector specifically designed to encode non-textual or auxiliary information—such as structured data, user profiles, image embeddings, or contextual metadata—so it can be integrated into a language model or other neural network alongside traditional text-based inputs. Unlike standard token embeddings that are derived from tokenized text using an embedding matrix, a supplemental embedding is generated through a separate transformation process that projects external vector data into the same or a compatible embedding space. This allows the model to interpret and process the supplemental data as if it were part of the input sequence. Supplemental embeddings enhance the model's ability to generate personalized, context-aware, or multimodal responses by providing it with additional background or task-relevant information that would otherwise be difficult or inefficient to encode through text alone.

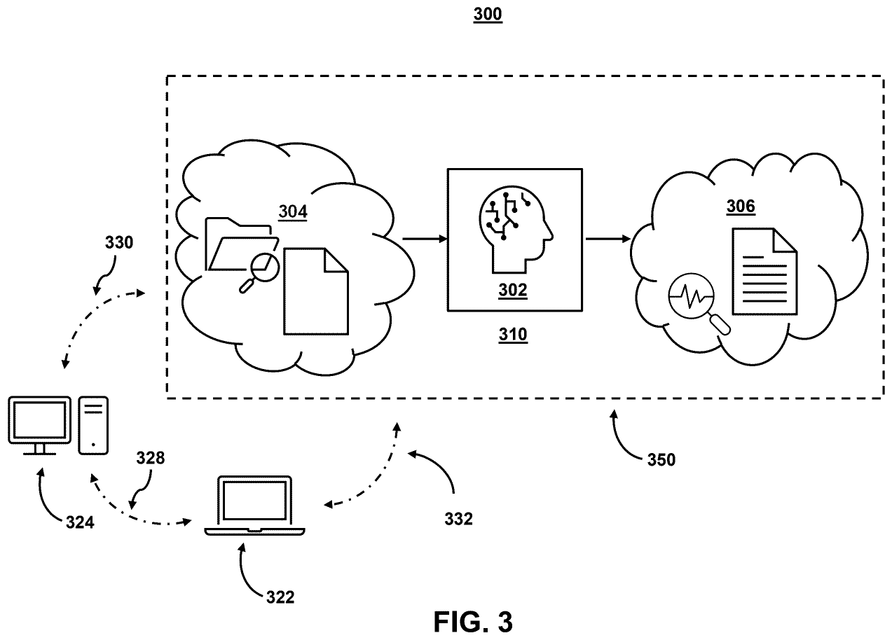

FIG. 3 shows illustrative components for a system used to process non-conforming data, in accordance with one or more embodiments. For example, FIG. 3 may show illustrative components for using mapping structures to process non-conforming data. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to generate a response.

Model 302 may be trained for each type of data using methods tailored to the nature of the data and the intended task. For text generation tasks, training typically involves using ground truth text data that reflects high-quality, user-preferred responses. One common approach is Supervised Fine-Tuning (SFT), which relies on a structured dataset composed of triplets: (1) a vector representing supplemental data—such as a user profile or embedding, (2) a prompt expressing a request or query, and (3) a target output text that has been explicitly selected or rated by a user as the preferred response. This approach directly teaches the model to associate vector-contextualized prompts with ideal outputs. Another powerful technique is Direct Preference Optimization (DPO), which incorporates user preference data more explicitly. DPO training datasets include: (1) a vector representation, (2) a prompt, (3) a positively rated text output, and (4) a negatively rated or dispreferred alternative. The model learns to rank or prefer one response over another by optimizing a loss function that encourages outputs aligning with user preferences.

In contrast, for geometric or structured data, such as spatial configurations, graphs, or 3D coordinates, the model's training process may need to include additional constraints or loss terms that capture the properties and rules intrinsic to geometric relationships. These might include enforcing symmetry, preserving distances, minimizing energy, or aligning with known physical laws. Custom loss functions or architecture modifications—such as equivariant layers or attention mechanisms that respect spatial invariance—are often introduced to ensure that the model handles geometric structure in a meaningful way. By adapting the training strategy to the nature of the data, the model can effectively generalize and perform across diverse input types and use cases.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

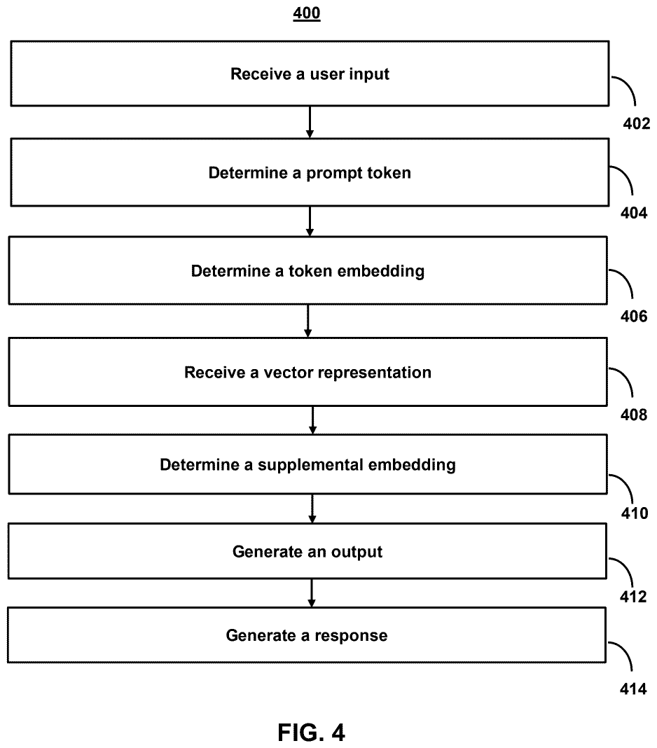

FIG. 4 shows a flowchart of the steps involved in for using mapping structures to process non-conforming data, in accordance with one or more embodiments. For example, the system may use process 400 (e.g., as implemented on one or more system components described above) in order to use mapping structures to process non-conforming data through computer networks

At step 402, process 400 (e.g., using one or more components described above) receives a user input. For example, the system may receive, via a user interface, a user input. For example, the system may receive a user input via a user interface by detecting and processing the actions or data entered by the user through interactive elements such as text fields, buttons, voice commands, touch gestures, or other input mechanisms. When a user engages with the interface—such as typing a query, clicking a button, or speaking a command—the interface captures that input and converts it into a structured format that the underlying system can interpret. This process may involve tokenizing text, digitizing voice, interpreting gesture coordinates, or encoding selections into predefined commands. The user input is then transmitted to the system's processing components, such as an application server or machine learning model, which analyzes the input in context—often in combination with supplemental data like user profiles or historical behavior—to determine the appropriate response. This interaction loop enables dynamic, real-time communication between the user and the system, forming the foundation for intelligent applications that adapt and respond to user needs.

At step 404, process 400 (e.g., using one or more components described above) determines a prompt token. For example, the system may determine a prompt token based on the user input. The system may determine a prompt token based on the user input by first passing the raw input—such as typed text—through a tokenizer, which segments the input into smaller units that the model can understand, such as words, subwords, or characters, depending on the specific tokenization scheme used. These segments, known as prompt tokens, serve as the atomic units of language processing for the model. The tokenizer maps each segment to a unique numerical identifier from the model's vocabulary, which is then used to retrieve a corresponding embedding vector from the model's embedding matrix. This conversion from natural language to prompt tokens ensures that the input is in a format suitable for processing by neural networks. The resulting sequence of prompt tokens preserves both the content and structure of the original user input, allowing the model to interpret meaning, context, and intent as it generates or classifies text. This process is critical for ensuring that the model can work effectively with a wide range of user inputs, regardless of length or complexity.

In some embodiments, the system may determine the prompt token based on the user input by determining a word in the user input and using the word to determine the prompt token. For example, the system may determine the prompt token based on the user input by first identifying individual words within the input text, typically using whitespace and punctuation as delimiters. Once a word is identified, the system applies a tokenization process to convert the word into one or more prompt tokens, depending on the tokenizer's design and vocabulary. For example, if the model uses subword tokenization—such as Byte Pair Encoding (BPE) or WordPiece—a single word may be split into multiple tokens if it is not found as a whole in the model's vocabulary. The tokenizer then maps each token to a unique identifier and retrieves its corresponding embedding vector from the model's embedding matrix. This approach enables the system to systematically transform natural language input into a sequence of tokens that the model can process. By determining a word and using it to generate one or more prompt tokens, the system preserves the semantic structure of the input while enabling efficient and accurate interpretation by the language model.

At step 406, process 400 (e.g., using one or more components described above) determines a token embedding. For example, the system may determine a token embedding based on the prompt token, wherein the token embedding is mapped to an input layer of a network based on a mapping structure. The system may determine a token embedding based on the prompt token by first using the prompt token—typically a unique numerical identifier corresponding to a word or subword fragment—as an index into an embedding matrix, which is a learned parameter of the model. This embedding matrix acts as a lookup table where each row represents a high-dimensional vector associated with a specific token in the model's vocabulary. When the prompt token is passed to the system, it retrieves the corresponding row from the embedding matrix, resulting in the token embedding. This token embedding encodes semantic and syntactic information about the token in a numerical form that can be understood by the model. The embedding is then mapped to the input layer of the network using a predefined mapping structure, which ensures compatibility with the model's architecture. This structure aligns the dimensions and format of the token embeddings with the network's expectations, enabling them to flow seamlessly into the model's processing pipeline, such as through attention mechanisms or feedforward layers. This process allows the system to transform raw user input into a rich, structured representation that the model can use for language understanding and generation.

In some embodiments, the system may determine the token embedding by determining, based on the mapping structure, a unique mapping of the prompt token to a node of the network and using the unique mapping to determine the token embedding. For example, the system may determine the token embedding by first referencing a mapping structure that defines a unique correspondence between each prompt token and a specific node—or position—in the input layer of the network. This mapping structure serves as a blueprint that ensures each token in the vocabulary has a dedicated or deterministically assigned location in the model's embedding space. When the system receives a prompt token, it uses this mapping to identify the exact node in the network's input layer to which the token corresponds. The system then accesses the embedding matrix, where each node contains a pre-initialized or learned vector representing the semantic meaning of its associated token. By retrieving the embedding vector from this uniquely mapped node, the system constructs the token embedding, which is a high-dimensional representation that captures contextual information about the token. This embedding is then fed into the network's processing layers. By enforcing a unique mapping between tokens and nodes, the system maintains consistency, avoids ambiguity, and ensures that each token's meaning is preserved and properly represented throughout the model's computational graph.

At step 408, process 400 (e.g., using one or more components described above) receives a vector representation. For example, the system may receive a vector representation of supplemental data. The system may receive a vector representation of supplemental data by accepting input from an external source—such as a database, user profile service, recommendation engine, or another machine learning model—that provides structured information in the form of a high-dimensional numerical vector. This vector representation encapsulates complex, context-rich data, such as user preferences, behavioral patterns, embeddings of prior documents, or even non-textual inputs like images or audio, which have been transformed into dense embeddings. The system is typically designed to accept this vector through a designated interface or API endpoint, which formats and transmits the data securely and efficiently. Once received, the vector may be validated, normalized, or transformed to ensure compatibility with the system's architecture. The vector can then be used as supplemental input alongside the primary user input (e.g., a text prompt), enabling the system to incorporate contextual or personalized information during processing. This allows for more adaptive, context-aware behavior from models, improving output quality, personalization, and task relevance across a wide range of applications.

In some embodiments, the system may receive the vector representation of the supplemental data by determining a plurality of domains based on the user input, generating one or more parameters for the supplemental data based on the plurality of domains, and using the one or more parameters to determine the supplemental data. For example, the system may receive the vector representation of supplemental data by first analyzing the user input to determine a plurality of relevant domains or contextual categories—such as topics, intents, user characteristics, or application-specific features—that are implied or explicitly referenced in the input. These domains help the system infer what types of supplemental information might enhance the response. Based on the identified domains, the system then generates one or more parameters that act as filters, selectors, or descriptors for retrieving the appropriate supplemental data. These parameters could include user identifiers, content categories, feature flags, or contextual tags. Using these parameters, the system queries an external data source or internal module—such as an embedding service, recommendation engine, or feature store—to locate and retrieve a vector representation that encodes the relevant supplemental data. This vector is designed to capture meaningful information aligned with the specified domains and is formatted for compatibility with the model's architecture. By dynamically determining the supplemental data in this way, the system ensures that the vector is both contextually appropriate and efficiently tailored to the user's input, enabling the model to produce more accurate, relevant, and personalized outputs.

At step 410, process 400 (e.g., using one or more components described above) determines a supplemental embedding. For example, the system may determine a supplemental embedding for the vector representation based on the mapping structure. The system may determine a supplemental embedding for the vector representation based on the mapping structure by applying a transformation that projects the vector into the same high-dimensional space used for token embeddings in the model. The mapping structure defines how input data—typically textual tokens—is converted into embeddings compatible with the model's input layer. To ensure consistency, the system leverages this structure as a reference for generating a supplemental embedding that aligns with the format and dimensionality of token embeddings. This is often achieved by passing the vector representation through a trainable projection layer or neural network module, such as a dense layer, that maps it to a vector of equivalent shape and distribution as the token embeddings. The mapping structure may also guide how the supplemental embedding is positioned in the model's input sequence—whether it is prepended, interleaved, or injected through cross-attention—ensuring it integrates seamlessly into the model's processing pipeline. By aligning the supplemental embedding with the mapping structure, the system allows the model to interpret and attend to the non-textual context just as it does with tokenized language, enabling richer, more context-aware language understanding and generation.

In some embodiments, the system may determine the supplemental embedding for the vector representation based on the mapping structure by determining a prompt length limit for the network and determining a size of the supplemental embedding based on the prompt length limit. For example, system may determine the supplemental embedding for the vector representation based on the mapping structure by first identifying the prompt length limit of the network, which defines the maximum number of tokens—or their equivalent embeddings—that the model can process in a single input sequence. This constraint is critical because large language models have fixed input capacities, and exceeding the prompt length can result in truncation or discarded information. Once the prompt length limit is known, the system evaluates how much of that limit is allocated to token embeddings derived from the user's prompt and how much space remains for incorporating supplemental data. Based on this assessment, the system determines an appropriate size for the supplemental embedding—either by selecting a fixed number of vectors or adjusting the dimensional compression of the vector representation—to ensure it fits within the allowed input budget. This decision may also involve reducing the dimensionality of the supplemental data or using pooling techniques to generate a compact but informative embedding. By scaling the supplemental embedding to conform to the prompt length limit while preserving its semantic value, the system ensures that both prompt tokens and contextual vector information can be jointly processed without exceeding the model's architectural constraints.

In some embodiments, the system may determine the supplemental embedding for the vector representation based on the mapping structure by determining a response time limit the network and modifying a size of the supplemental embedding based on the response time limit. For example, the system may determine the supplemental embedding for the vector representation based on the mapping structure by incorporating a response time limit as a constraint on computational efficiency. First, the system identifies the allowable response time for generating output—whether defined by user experience requirements, application latency budgets, or hardware limitations. Since the size of the input directly influences processing time in large language models, the system evaluates how the inclusion of a supplemental embedding will impact inference speed. If the response time limit is tight, the system may reduce the size of the supplemental embedding by decreasing its dimensionality, truncating less relevant features, or compressing the vector through pooling or projection techniques. Conversely, if there is greater flexibility in response time, the system may include a richer or higher-dimensional supplemental embedding that provides more context to the model. The mapping structure ensures that the modified embedding remains aligned with the token embeddings in terms of format and compatibility. This dynamic adjustment enables the system to balance contextual richness with real-time responsiveness, ensuring that the supplemental data enhances output quality without violating time constraints.

In some embodiments, the system may determine the supplemental embedding for the vector representation based on the mapping structure by determining a size of the vector representation, determining, based on the mapping structure, that the size exceeds a size limit for the input layer, and, in response to determining that the size exceeds the size limit, determining to truncate the vector representation to determine the supplemental embedding. For example, the system may determine the supplemental embedding for the vector representation based on the mapping structure by first evaluating the size of the incoming vector representation, which encodes supplemental data such as user context or other non-textual information. The system then consults the mapping structure to assess whether the size of this vector exceeds the size limit imposed by the model's input layer—either in terms of dimensionality or the total number of embeddings that can be processed within a single input sequence. If the system determines that the vector's size surpasses this threshold, it initiates a truncation strategy to reduce the vector to a permissible size while retaining as much relevant information as possible. This truncation may involve selecting the most important dimensions, applying dimensionality reduction techniques like principal component analysis (PCA) or attention-based weighting, or segmenting and retaining only a subset of the vector's components. The resulting reduced vector is then transformed into a supplemental embedding that is aligned with the model's token embedding space through the established mapping structure. This process ensures that the supplemental embedding conforms to the model's architectural limits while still contributing meaningful context to the language model's input.

In some embodiments, the system may determine the supplemental embedding for the vector representation based on the mapping structure by determining a size of the vector representation, determining, based on the mapping structure, that the size is below a size limit for the input layer, and, in response to determining that the size is below the size limit, determining to populate the supplemental embedding with one or more placeholder values. For example, the system may determine the supplemental embedding for the vector representation based on the mapping structure by first measuring the size of the vector representation intended to provide supplemental context. It then compares this size to a predefined size limit for the input layer, as specified by the mapping structure that governs how embeddings are formatted and processed within the model. If the system determines that the size of the vector representation is below the acceptable threshold—meaning it does not fully utilize the available input capacity—it may respond by populating the remaining portion of the supplemental embedding with one or more placeholder values. These placeholder values could be zero vectors, learned padding embeddings, or neutral tokens designed to preserve the positional integrity of the input and avoid introducing bias or noise. The use of placeholders ensures that the final supplemental embedding conforms to the fixed input size expected by the model, maintaining structural consistency with token embeddings while preventing misalignment in attention or positional encoding mechanisms. This strategy enables the model to handle variable-sized supplemental vectors without compromising architectural integrity or performance.

In some embodiments, the system may determine the supplemental embedding for the vector representation based on the mapping structure by determining a dimensional characteristic of the vector representation, determining, based on the mapping structure, that the dimensional characteristic does not correspond to a threshold characteristic for the input layer, and, in response to determining that the dimensional characteristic does not correspond to the threshold characteristic for the input layer, determining a latent index of the vector representation to determine the supplemental embedding. For example, the system may determine the supplemental embedding for the vector representation based on the mapping structure by first analyzing a dimensional characteristic of the vector representation, such as its length, depth, or feature distribution. The system then compares this characteristic against a threshold defined by the mapping structure, which specifies the required or optimal dimensional properties for inputs to the model's input layer. If it determines that the vector's dimensional characteristic does not meet this threshold—meaning it may be too sparse, misaligned, or of incompatible size—the system responds by identifying a latent index within the vector representation. This latent index refers to a subset or transformation of the original vector that captures the most semantically meaningful or representative features within a reduced or remapped space. By extracting or computing this latent index, the system effectively distills the high-dimensional vector into a form that aligns with the model's input constraints, allowing it to generate a supplemental embedding that fits the required format. This embedding can then be integrated with token embeddings in a structurally and semantically coherent way, enabling the model to process the supplemental context without violating architectural thresholds or compromising performance.

In some embodiments, the system may determine the supplemental embedding for the vector representation based on the mapping structure by determining, based on the mapping structure, a projection layer for processing the vector representation and using the projection layer to determine supplemental embedding. For example, the system may determine the supplemental embedding for the vector representation based on the mapping structure by first identifying, within that structure, a designated projection layer specifically configured to process external vector inputs. The mapping structure includes the architectural blueprint that defines how various types of input—particularly non-tokenized supplemental data—are adapted for compatibility with the model's input space. Upon receiving a vector representation, such as a user embedding or contextual feature vector, the system references the mapping structure to locate the appropriate projection layer, which is typically a trainable neural network component (e.g., a dense or feedforward layer). This projection layer transforms the raw vector into a high-dimensional embedding that matches the format, scale, and dimensionality of standard token embeddings used by the model. By applying this transformation, the system ensures that the supplemental embedding can be integrated seamlessly into the model's input pipeline, whether as an additional token, prefix, or side input. This method maintains architectural consistency, enables efficient fusion of supplemental data with textual prompts, and enhances the model's ability to generate contextually informed outputs.

At step 412, process 400 (e.g., using one or more components described above) generates an output. For example, the system may process the token embedding and the supplemental embedding through the network to generate an output. For example, the system may process the token embedding and the supplemental embedding through the network by first combining or integrating both types of embeddings in a way that preserves their individual contributions while ensuring compatibility with the model's architecture. This typically begins at the input layer, where the token embeddings—derived from the user's textual prompt—and the supplemental embedding—generated from external vector representations—are aligned in terms of dimensionality and format. The system may concatenate them, interleave them, or position the supplemental embedding as a prefix or special token within the input sequence. Once combined, the joint input is passed through the network's layers, beginning with the self-attention mechanism in transformer-based models. During this process, the model dynamically weighs the importance of each embedding through attention scores, enabling it to contextualize the prompt in light of the supplemental information. The combined embeddings are propagated through successive layers of the network, where they are transformed, aggregated, and used to model complex relationships. Eventually, the final hidden states are decoded—depending on the task—into an output such as a generated text, a classification label, or a ranked result. This integrated processing approach allows the system to leverage both explicit user input and rich contextual data to produce more accurate, relevant, and personalized outputs.

In some embodiments, the system may process the token embedding and the supplemental embedding through the network to generate the output by receiving training data comprising historical supplemental data, historical prompt tokens, and labeled outputs indicating preferred outputs based on the historical supplemental data and the historical prompt tokens and training the network using the training data. For example, the system may process the token embedding and the supplemental embedding through the network to generate the output by first receiving training data that includes historical supplemental data, historical prompt tokens, and labeled outputs that indicate preferred responses or actions based on those inputs. The historical supplemental data, often in the form of structured embeddings such as user profiles or contextual vectors, provides auxiliary information relevant to the task, while the historical prompt tokens represent previously issued user inputs in tokenized form. The labeled outputs serve as ground truth examples that reflect ideal or user-preferred responses generated in the context of the corresponding supplemental and prompt inputs. During training, the system converts the prompt tokens and supplemental data into their respective embeddings using the model's mapping and projection structures. These embeddings are then jointly processed through the network, typically using attention mechanisms that allow the model to learn how to appropriately weigh and integrate both types of input. By minimizing a loss function that measures the difference between the model's generated output and the labeled output, the system adjusts its internal parameters to improve performance. Over time, the network learns to associate specific patterns of prompt and supplemental information with high-quality outputs, enabling it to generalize and generate accurate, context-aware responses during inference.

In some embodiments, the system may process the token embedding and the supplemental embedding through the network to generate the output by receiving training data comprising historical supplemental data, historical prompt tokens, and labeled outputs indicating preferred outputs based on the historical supplemental data and the historical prompt tokens and training, using the training data, the network using supervised fine tuning. For example, the system may process the token embedding and the supplemental embedding through the network to generate the output by employing supervised fine-tuning (SFT) with training data that includes historical supplemental data, historical prompt tokens, and labeled outputs indicating preferred responses. In this approach, the historical prompt tokens—derived from prior user inputs—are converted into token embeddings using the model's embedding layer, while the historical supplemental data—such as user embeddings or contextual vectors—are transformed into supplemental embeddings through a projection layer aligned with the model's input structure. The labeled outputs represent ideal or user-preferred responses corresponding to each prompt-supplemental pair. During supervised fine-tuning, the system feeds both the token and supplemental embeddings into the network, typically combining them as a single input sequence or integrating them via special positions in the model's architecture. The network processes these inputs through its layers—such as attention mechanisms and feedforward blocks—to produce an output, which is then compared against the labeled response. A loss function, often cross-entropy for language generation tasks, measures the deviation between the model's output and the labeled output, and backpropagation is used to update the network's weights accordingly. Over time, this process enables the model to learn how to effectively incorporate both user input and contextual data to produce high-quality, context-aware outputs that align with demonstrated user preferences.

In some embodiments, the system may process the token embedding and the supplemental embedding through the network to generate the output by receiving training data comprising historical supplemental data, historical prompt tokens, first labeled outputs indicating preferred outputs based on the historical supplemental data and the historical prompt tokens, and second labeled outputs indicating not preferred outputs based on the historical supplemental data and the historical prompt tokens and training, using the training data, the network using direct preference optimization. For example, the system may process the token embedding and the supplemental embedding through the network to generate the output by using training data comprising historical supplemental data, historical prompt tokens, first labeled outputs that represent preferred responses, and second labeled outputs that reflect less preferred or dispreferred responses, applying a technique known as Direct Preference Optimization (DPO). In this approach, the system first converts the historical prompt tokens into token embeddings using its embedding matrix and transforms the historical supplemental data—such as user profiles or contextual embeddings—into supplemental embeddings through a designated projection layer. These embeddings are then jointly input into the network, simulating how the model would process such information during inference. For each training example, the model generates outputs corresponding to both the preferred and non-preferred responses. Rather than optimizing for accuracy against a single labeled output, DPO trains the network to rank the preferred response higher than the dispreferred one using a preference-based loss function, such as a contrastive or pairwise ranking loss. This training method encourages the model to learn fine-grained distinctions in output quality by aligning its internal representations and generation behavior with demonstrated user preferences. Over time, this allows the network to not only incorporate both textual and contextual embeddings effectively but also prioritize outputs that are more aligned with human judgment, leading to more accurate, relevant, and user-aligned responses during real-world use.

In some embodiments, the system may process the token embedding and the supplemental embedding through the network to generate the output by generating, based on the mapping structure, a combined feature input based on the token embedding and the supplemental embedding and inputting the combined feature input into the network. For example, the system may process the token embedding and the supplemental embedding through the network to generate the output by first generating a combined feature input that integrates both embeddings according to the mapping structure. The mapping structure defines how different types of embeddings—such as token embeddings derived from user input and supplemental embeddings derived from external vector representations—can be aligned and merged into a format suitable for the network's input layer. Using this structure, the system determines the appropriate method of combining the embeddings, which may involve concatenation, interpolation, or inserting the supplemental embedding as a special token or prefix within the token sequence. The combined feature input preserves the semantic content of the original prompt while enriching it with additional contextual information encoded in the supplemental embedding. This unified input is then passed into the network, where attention mechanisms and neural layers process the full context holistically, enabling the model to generate an output that reflects both the immediate user input and any relevant background or personalized data. This approach ensures architectural consistency, improves contextual understanding, and enhances the quality and relevance of the model's output.

At step 414, process 400 (e.g., using one or more components described above) generates a response. For example, the system may generate for display, on the user interface, a response based on the output. The system may generate a response for display on the user interface by first interpreting the output produced by the network—typically in the form of a text sequence, decision, or structured data—and formatting it into a user-friendly, context-appropriate representation. Once the model has processed the token embedding and supplemental embedding through its layers and generated an output, the system post-processes this output to ensure it is coherent, relevant, and properly aligned with the original user input. This may include converting token sequences back into natural language using a detokenizer, applying formatting rules, or incorporating visual or interactive elements, depending on the application. The system then transmits the finalized response to the user interface layer, where it is rendered in a format that supports easy comprehension and engagement—such as displaying a chatbot message, populating a results panel, or generating a visual recommendation. By managing this transition from raw model output to user-facing content, the system ensures that the user receives clear, actionable, and contextually informed feedback in a seamless and responsive manner.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for using mapping structures to process non-conforming data through computer networks.
2. The method of any one of the preceding embodiments, further comprising: receiving, via a user interface, a user input; determining a prompt token based on the user input; determining a token embedding based on the prompt token, wherein the token embedding is mapped to an input layer of a network based on a mapping structure; receiving a vector representation of supplemental data; determining a supplemental embedding for the vector representation based on the mapping structure; processing the token embedding and the supplemental embedding through the network to generate an output; and generating for display, on the user interface, a response based on the output.
3. The method of any one of the preceding embodiments, wherein determining the supplemental embedding for the vector representation based on the mapping structure further comprises: determining a prompt length limit for the network; and determining a size of the supplemental embedding based on the prompt length limit.
4. The method of any one of the preceding embodiments, wherein determining the supplemental embedding for the vector representation based on the mapping structure further comprises: determining a response time limit the network; and modifying a size of the supplemental embedding based on the response time limit.
5. The method of any one of the preceding embodiments, wherein determining the supplemental embedding for the vector representation based on the mapping structure further comprises: determining a size of the vector representation; determining, based on the mapping structure, that the size exceeds a size limit for the input layer; and in response to determining that the size exceeds the size limit, determining to truncate the vector representation to determine the supplemental embedding.
6. The method of any one of the preceding embodiments, wherein determining the supplemental embedding for the vector representation based on the mapping structure further comprises: determining a size of the vector representation; determining, based on the mapping structure, that the size is below a size limit for the input layer; and in response to determining that the size is below the size limit, determining to populate the supplemental embedding with one or more placeholder values.
7. The method of any one of the preceding embodiments, wherein determining the supplemental embedding for the vector representation based on the mapping structure further comprises: determining a dimensional characteristic of the vector representation; determining, based on the mapping structure, that the dimensional characteristic does not correspond to a threshold characteristic for the input layer; and in response to determining that the dimensional characteristic does not correspond to the threshold characteristic for the input layer, determining a latent index of the vector representation to determine the supplemental embedding.
8. The method of any one of the preceding embodiments, wherein determining the supplemental embedding for the vector representation based on the mapping structure further comprises: determining, based on the mapping structure, a projection layer for processing the vector representation; and using the projection layer to determine supplemental embedding.
9. The method of any one of the preceding embodiments, wherein determining the token embedding further comprises: determining, based on the mapping structure, a unique mapping of the prompt token to a node of the network; and using the unique mapping to determine the token embedding.
10. The method of any one of the preceding embodiments, wherein determining the prompt token based on the user input further comprises: determining a word in the user input; and using the word to determine the prompt token.
11. The method of any one of the preceding embodiments, wherein processing the token embedding and the supplemental embedding through the network to generate the output further comprises: receiving training data comprising historical supplemental data, historical prompt tokens, and labeled outputs indicating preferred outputs based on the historical supplemental data and the historical prompt tokens; and training the network using the training data.
12. The method of any one of the preceding embodiments, wherein processing the token embedding and the supplemental embedding through the network to generate the output further comprises: receiving training data comprising historical supplemental data, historical prompt tokens, and labeled outputs indicating preferred outputs based on the historical supplemental data and the historical prompt tokens; and training, using the training data, the network using supervised fine tuning.
13. The method of any one of the preceding embodiments, wherein processing the token embedding and the supplemental embedding through the network to generate the output further comprises: receiving training data comprising historical supplemental data, historical prompt tokens, first labeled outputs indicating preferred outputs based on the historical supplemental data and the historical prompt tokens, and second labeled outputs indicating not preferred outputs based on the historical supplemental data and the historical prompt tokens; and training, using the training data, the network using direct preference optimization.
14. The method of any one of the preceding embodiments, wherein processing the token embedding and the supplemental embedding through the network to generate the output comprises: generating, based on the mapping structure, a combined feature input based on the token embedding and the supplemental embedding; and inputting the combined feature input into the network.
15. The method of any one of the preceding embodiments, wherein receiving the vector representation of the supplemental data further comprises: determining a plurality of domains based on the user input; generating one or more parameters for the supplemental data based on the plurality of domains; and using the one or more parameters to determine the supplemental data.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. (canceled)

2. A method for using mapping structures to process non-conforming data through computer networks, the method comprising:
receiving, via a user interface, a user input;
determining a prompt token based on the user input;
determining a token embedding based on the prompt token, wherein the token embedding is mapped to an input layer of a network based on a mapping structure;
receiving a vector representation of supplemental data;
determining a supplemental embedding for the vector representation based on the mapping structure;
processing the token embedding and the supplemental embedding through the network to generate an output; and
generating for display, on the user interface, a response based on the output.

3. The method of claim 2, wherein determining the supplemental embedding for the vector representation based on the mapping structure further comprises:
determining a prompt length limit for the network; and
determining a size of the supplemental embedding based on the prompt length limit.

4. The method of claim 2, wherein determining the supplemental embedding for the vector representation based on the mapping structure further comprises:
determining a response time limit the network; and
modifying a size of the supplemental embedding based on the response time limit.

5. The method of claim 2, wherein determining the supplemental embedding for the vector representation based on the mapping structure further comprises:
determining a size of the vector representation;
determining, based on the mapping structure, that the size exceeds a size limit for the input layer; and
in response to determining that the size exceeds the size limit, determining to truncate the vector representation to determine the supplemental embedding.

6. The method of claim 2, wherein determining the supplemental embedding for the vector representation based on the mapping structure further comprises:
determining a size of the vector representation;
determining, based on the mapping structure, that the size is below a size limit for the input layer; and
in response to determining that the size is below the size limit, determining to populate the supplemental embedding with one or more placeholder values.

7. The method of claim 2, wherein determining the supplemental embedding for the vector representation based on the mapping structure further comprises:
determining a dimensional characteristic of the vector representation;
determining, based on the mapping structure, that the dimensional characteristic does not correspond to a threshold characteristic for the input layer; and
in response to determining that the dimensional characteristic does not correspond to the threshold characteristic for the input layer, determining a latent index of the vector representation to determine the supplemental embedding.

8. The method of claim 2, wherein determining the supplemental embedding for the vector representation based on the mapping structure further comprises:
determining, based on the mapping structure, a projection layer for processing the vector representation; and
using the projection layer to determine supplemental embedding.

9. The method of claim 2, wherein determining the token embedding further comprises:
determining, based on the mapping structure, a unique mapping of the prompt token to a node of the network; and
using the unique mapping to determine the token embedding.

10. The method of claim 2, wherein determining the prompt token based on the user input further comprises:
determining a word in the user input; and
using the word to determine the prompt token.

11. The method of claim 2, wherein processing the token embedding and the supplemental embedding through the network to generate the output further comprises:
receiving training data comprising historical supplemental data, historical prompt tokens, and labeled outputs indicating preferred outputs based on the historical supplemental data and the historical prompt tokens; and
training the network using the training data.

12. The method of claim 2, wherein processing the token embedding and the supplemental embedding through the network to generate the output further comprises:
receiving training data comprising historical supplemental data, historical prompt tokens, and labeled outputs indicating preferred outputs based on the historical supplemental data and the historical prompt tokens; and
training, using the training data, the network using supervised fine tuning.

13. The method of claim 2, wherein processing the token embedding and the supplemental embedding through the network to generate the output further comprises:
receiving training data comprising historical supplemental data, historical prompt tokens, first labeled outputs indicating preferred outputs based on the historical supplemental data and the historical prompt tokens, and second labeled outputs indicating not preferred outputs based on the historical supplemental data and the historical prompt tokens; and
training, using the training data, the network using direct preference optimization.

14. The method of claim 2, wherein processing the token embedding and the supplemental embedding through the network to generate the output comprises:
generating, based on the mapping structure, a combined feature input based on the token embedding and the supplemental embedding; and
inputting the combined feature input into the network.

15. The method of claim 2, wherein receiving the vector representation of the supplemental data further comprises:
determining a plurality of domains based on the user input;
generating one or more parameters for the supplemental data based on the plurality of domains; and
using the one or more parameters to determine the supplemental data.

16. One or more non-transitory, computer-readable media, comprising instructions that, when executed by one or more processors, cause operations comprising:
determining a prompt token based on a user input;
determining a token embedding based on the prompt token, wherein the token embedding is mapped to an input layer of a network based on a mapping structure;
receiving a vector representation of supplemental data;
determining a supplemental embedding for the vector representation based on the mapping structure; and
processing the token embedding and the supplemental embedding through the network to generate an output.

17. The one or more non-transitory, computer-readable media of claim 16, wherein determining the supplemental embedding for the vector representation based on the mapping structure further comprises:
determining a prompt length limit for the network; and
determining a size of the supplemental embedding based on the prompt length limit.

18. The one or more non-transitory, computer-readable media of claim 16, wherein determining the supplemental embedding for the vector representation based on the mapping structure further comprises:
determining a response time limit the network; and
modifying a size of the supplemental embedding based on the response time limit.

19. The one or more non-transitory, computer-readable media of claim 16, wherein determining the supplemental embedding for the vector representation based on the mapping structure further comprises:
determining a size of the vector representation;
determining, based on the mapping structure, that the size exceeds a size limit for the input layer; and
in response to determining that the size exceeds the size limit, determining to truncate the vector representation to determine the supplemental embedding.

20. The one or more non-transitory, computer-readable media of claim 16, wherein receiving the vector representation of the supplemental data further comprises:
determining a plurality of domains based on the user input;
generating one or more parameters for the supplemental data based on the plurality of domains; and
using the one or more parameters to determine the supplemental data.

21. The one or more non-transitory, computer-readable media of claim 16, wherein processing the token embedding and the supplemental embedding through the network to generate the output comprises:
generating a combined feature input based on the token embedding and the supplemental embedding; and
inputting the combined feature input into the network.
